(19) United States
(12) Patent Application Publication
(10) Pub. No.: US 2025/0373677 A1
(43) Pub. Date: Dec. 4, 2025

(54) SYSTEMS AND METHODS FOR QUANTIFYING NETWORK QUALITY USING A SCORING MODEL

(71) Applicant: CABLE TELEVISION LABORATORIES, INC., Louisville, CO (US)

(72) Inventors: Paul Fonte, Arvada, CO (US); Shafayet Khan, Littleton, CO (US); Tyler Glenn, Kalispell, MT (US); Lin Cheng, Superior, CO (US)

(21) Appl. No.: 19/222,001

(22) Filed: May 29, 2025

Related U.S. Application Data
(60) Provisional application No. 63/653,106, filed on May 29, 2024.
(60) Provisional application No. 63/757,616, filed on Feb. 12, 2025.

(51) Int. Cl. H04L 65/80; H04L 43/08

(52) U.S. Cl. CPC H04L 65/80; H04L 43/08

(57) ABSTRACT

Systems and methods for quantifying network quality using a scoring model are provided. At least one measurement is received by an analysis agent and inputted into a scoring model. The scoring model comprises a machine learning model configured to receive the at least one measurement, input the at least one measurement into a plurality of functions, weight the output of each function by a corresponding weight of a plurality of weights, and combine the weighted output to generate an end user score. The end user score is compared to a predetermined threshold.

### CROSS REFERENCE TO RELATED APPLICATIONS

This application claims the benefit of and priority to U.S. Provisional Application No. 63/653,106, filed on May 29, 2024, and 63/757,616, filed on Feb. 12, 2025, which applications are incorporated herein by reference in their entireties.

### BACKGROUND

The field of the disclosure relates generally to quantifying network quality, and more particularly, to quantifying network quality using a scoring model.

Network as a Service (NaaS) is a common application programming interface (API) across operators targeting multi-access networks that enables network-aware application deployment and enhanced performance. NaaS enables developers, internal operations, and hyperscalers the ability to request network services, exchange data, and automate deployment of applications. By leveraging standard intent-based APIs that expose network services and data while reducing the complexity and domain knowledge of the underlying access technology, new relationships between network operators and third-party developers can be established more seamlessly.

However, end users and Multiple System Operators (MSOs) may become frustrated when, for example, an end user's internet does not work properly at the desired location. If the end user's internet appears to be running slowly or a video conference call or a tv show freezes and/or buffers, then the end user may get frustrated with the MSO. In such instances, determining the root cause of the issue can be difficult for both the end user and the MSO as there is currently no communication system between the end user's application and the network.

### SUMMARY

Systems and methods are provided for estimating network quality using a scoring model that receives measurements from a network and an end user application operating over the network as input and outputs an end user score that can be, for example, a scalar value. The end user score can be used to determine whether the end user application is experiencing an impairment and a resolution can be determined and provided to improve or resolve the impairment.

A method according to at least one embodiment of the present disclosure comprises receiving, by an analysis agent, at least one measurement; inputting, by the analysis agent, the at least one measurement into a scoring model comprising a machine learning model configured to: receive the at least one measurement; input the at least one measurement into a plurality of functions; weight the output of each function by a corresponding weight of a plurality of weights; and combine the weighted output to generate the end user score; and comparing, by the analysis agent, the end user score to a predetermined threshold.

Any of the aspects herein, further comprising: determining that the end user application is experiencing an impairment in response to the end user score being less than the predetermined threshold; identifying a type and a location of the impairment; and determining a resolution action for the impairment based on type and the location of the impairment.

Any of the aspects herein, wherein the predetermined threshold comprises at least three ranges of values, and wherein the impairment is determined when the end user score is within two of the three ranges of values.

Any of the aspects herein, wherein the plurality of weights are manually defined by a developer.

Any of the aspects herein, wherein the plurality of functions are trained using labeled training data having a plurality of training data, each training data having at least one measurement and a corresponding training score.

Any of the aspects herein, wherein the at least one measurement comprises at least one application KPI received from a first (API) in communication with the end user application and network data received from a second API in communication with a network.

Any of the aspects herein, wherein the at least one application KPI comprises bandwidth, framerate, packet latency, jitter, bit rate, and packet loss and the network data comprises packet latency, jitter, bit rate, and packet loss

Any of the aspects herein, wherein the at least one measurement is collected in the cloud and stored in at least one of a remote server or a remote database.

Any of the aspects herein, wherein the end user score is a scalar number.

A system according to at least one embodiment of the present disclosure comprises a first API in communication with an end user application and configured to receive at least one application KPI from the end user application; and a second API in communication with a network and configured to receive network data; an analysis agent in communication with the first API and the second API, the analysis agent configured to: receive, in real-time, the at least one application KPI from the first API and the network data from the second API; input the at least one application KPI and the network data into a scoring model that outputs an end user score, the end user score correlating to whether the end user application's internet connection is impaired; compare the end user score to a predetermined threshold; determine that the end user application is experiencing an impairment in response to the end user score is less than the predetermined threshold; identify a type and a location of the impairment; and determine a resolution action for the impairment based on type and the location of the impairment.

Any of the aspects herein, wherein the predetermined threshold comprises at least three ranges of values, and wherein the impairment is determined when the end user score is within two of the three ranges of values.

Any of the aspects herein, wherein the analysis agent is further configured to transmit instructions for the resolution action to at least one of an end user, a developer, or a network operator.

Any of the aspects herein, wherein the analysis agent operates on at least one of a cloud network, a remote server, or a remote database.

Any of the aspects herein, wherein the at least one application KPI and network data are collected in the cloud and stored in at least one of a remote server or a remote database.

Any of the aspects herein, wherein the at least one application KPI comprises bandwidth, framerate, packet latency, jitter, bit rate, and packet loss and the network data comprises packet latency, jitter, bit rate, and packet loss.

Any of the aspects herein, wherein the end user score is a scalar number.

Any of the aspects herein, wherein the scoring model is a machine learning model configured to: receive the at least one application KPI and the network data; input the at least one application KPI and the network data into a plurality of functions; weight the output of each function by a corresponding weight of a plurality of weights; and combine the weighted output to generate the end user score.

Any of the aspects herein, wherein the plurality of weights are manually defined by a developer.

Any of the aspects herein, wherein the plurality of functions of the scoring model are trained using labeled training data having a plurality of training data, each training data having at least one training KPIs, training network data, and a corresponding training score.

A system according to at least one embodiment of the present disclosure comprises a first API in communication with an end user application and configured to receive at least one application KPI from the end user application; and a second API in communication with a network and configured to receive network data; an analysis agent in communication with the first API and the second API, the analysis agent configured to: receive, in real-time, the at least one application KPI from the first API and the network data from the second API; input the at least one application KPI and the network data into a scoring model that outputs an end user score, the end user score correlating to whether the end user application's internet connection is impaired, wherein the scoring model is a machine learning model configured to: receive the at least one application KPI and the network data; input the at least one application KPI and the network data into a plurality of functions; weight the output of each function by a corresponding weight of a plurality of weights; and combine the weighted output to generate the end user score; compare the end user score to a predetermined threshold; determine that the end user application is experiencing an impairment in response to the end user score being less than the predetermined threshold; identify a type and a location of the impairment; and determine a resolution action for the impairment based on type and the location of the impairment.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a schematic illustration of a system that uses Network as a Service (Naas) according to at least one embodiment of the present disclosure;

FIG. 2 is a schematic diagram of a system for estimating a network quality according to at least one embodiment of the present disclosure;

FIG. 3 is an example graphical user interface according to at least one embodiment of the present disclosure;

FIG. 4 is a dataflow according to at least one embodiment of the present disclosure;

FIG. 5 is a logical topology according to at least one embodiment of the present disclosure;

FIG. 6A is a schematic diagram of training a scoring model according to at least one embodiment of the present disclosure;

FIG. 6B is a schematic diagram of a structure of the scoring model according to at least one embodiment of the present disclosure;

FIG. 7 is a flowchart according to at least one embodiment of the present disclosure; and

FIG. 8 is a flowchart according to at least one embodiment of the present disclosure.

### DETAILED DESCRIPTION

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (i.e., X₁ and X₂) as well as a combination of elements selected from two or more classes (i.e., Y₁ and Zₒ).

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, i.e., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “agent” is a computer program that can perform tasks autonomously or semi-autonomously on behalf of a user or a system. In other words, the agent can operate independently of a human user or operator.

Furthermore, as used herein, the term “real-time” refers to at least one of the time of occurrence of the associated events, the time of measurement and collection of predetermined data, the time for a computing device (i.e., a processor) to process the data, and the time of a system response to the events and the environment. In the embodiments described herein, these activities and events occur substantially instantaneously.

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, i.e., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

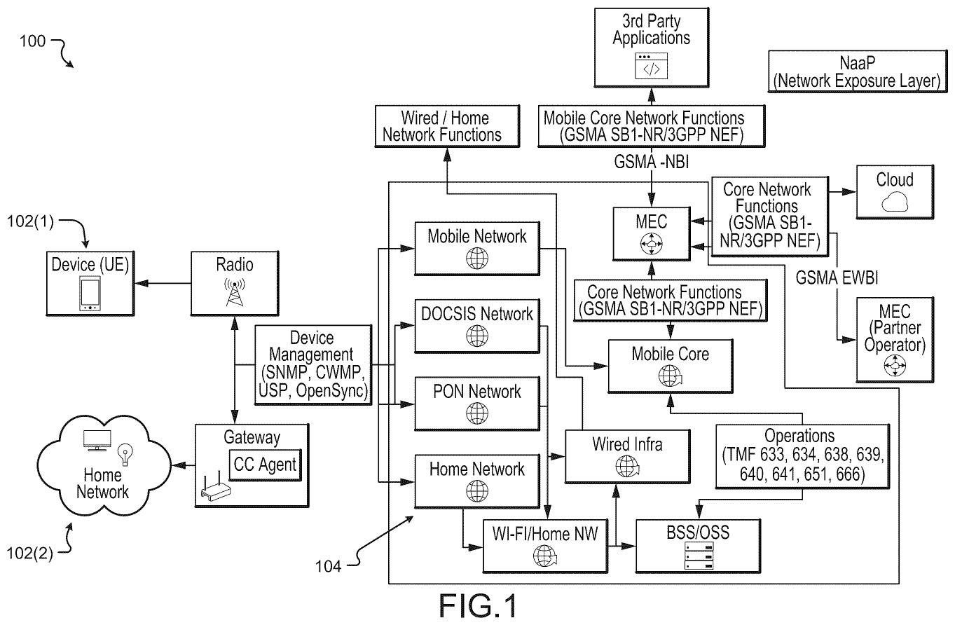

Turning to FIG. 1, a schematic illustration depicting a Network as a Service (NaaS) system (100) is provided for reference. As shown, multiple end users (102(1)), (102(2)) may access multiple networks (104) via the NaaS system (100). However, as previously described, a conventional NaaS system (100) cannot identify a location or root cause of an issue that occurs at an end user (102). For example, the root cause may be an issue at one of the networks (104); however, network data to determine such issue is not available to the end user (102). Similarly, the root cause may be an issue at the end user (102); however, end user data such as application key performance indicators (KPIs) are not available to the networks (104). Thus, it is desirable to monitor a quality of the end user's (102) network user to: determine when the end user's (102) use is impaired by quantifying the network quality using a scoring model, to identify a type and a location of the impairment, and to determine a resolution action for the impairment.

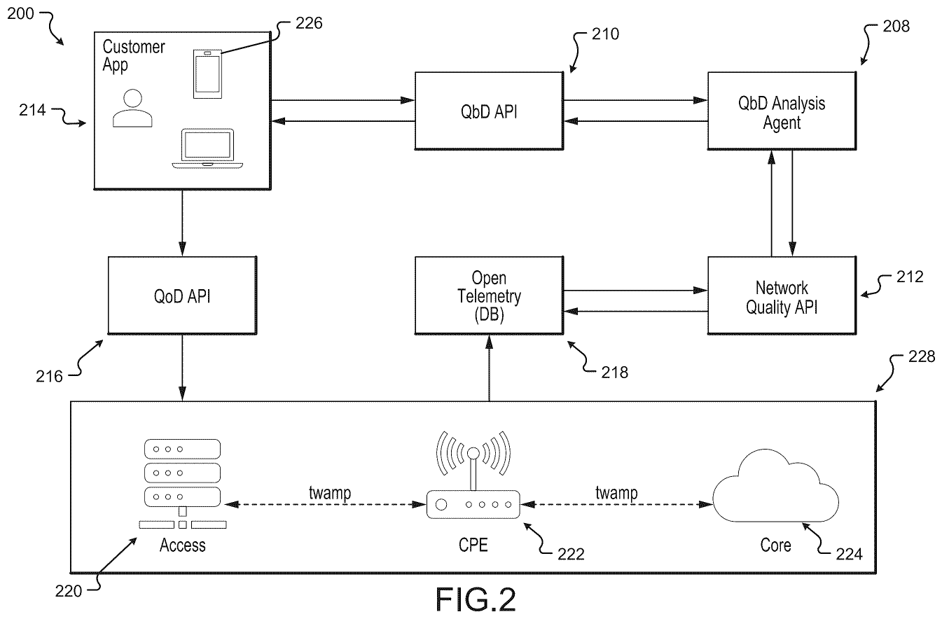

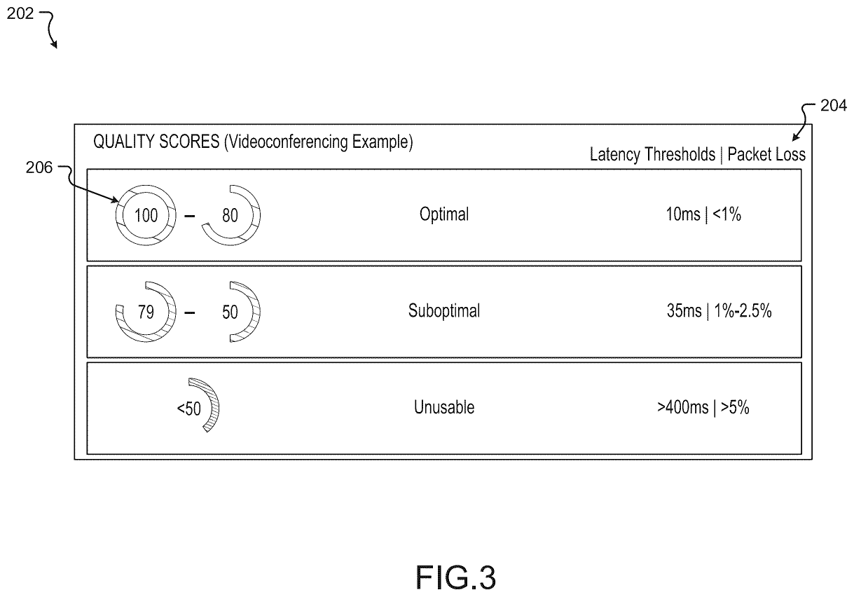

Turning to FIGS. 2 and 3, a schematic diagram of a system (200) for determining an impairment to an end user's network connection by quantifying the network quality and an example graphical user interface (GUI) (202) of predetermined thresholds (204) are respectively shown. The system (200) is used to monitor a quality of the end user's (102) use by determining an end user score (236) (labelled in FIGS. 3, 4, 5, 6A, and 6B) based on data received from the end users (102) and the networks (104) and determining a resolution action when the end user (102) experiences an impairment to their use.

As shown in FIG. 2, the system (200) includes an analysis agent (208) in communication with a first API (210) and a second API (212). The analysis agent (208) is an agent that can perform tasks related to receiving and analyzing application KPI(s) and network data. The analysis agent (208) can, for example, run a scoring model (234) using the application KPI(s), network data, and other measurements as input into the scoring model (234).

The first API (210) is also in communication with an end user application (214) and the second API (212) is also in communication with a data collector (218). The end user application (214) is also in communication with a third API (216), which may be in communication with an access network (220). The access network (220) is also in communication with a customer premises equipment (CPE) (222), which is in communication with a core network (224). The data collector (218) is also in communication with the CPE (222).

The first API (210) may be referred to as a gateway or quality by design API, the second API (212) may be referred to as a network quality API, and the third API (216) may be referred to as a quality on demand API. It will be appreciated that the first API (210), the second API (212), the third API (216), or any API may be, for example, a CAMARA based API.

The end user application (214) operates on a user device (226) such as, for example, a smart phone, a smart watch, a computing device, a laptop, or the like. The end user application (214) also operates over a network (228) via the NaaS system (100).

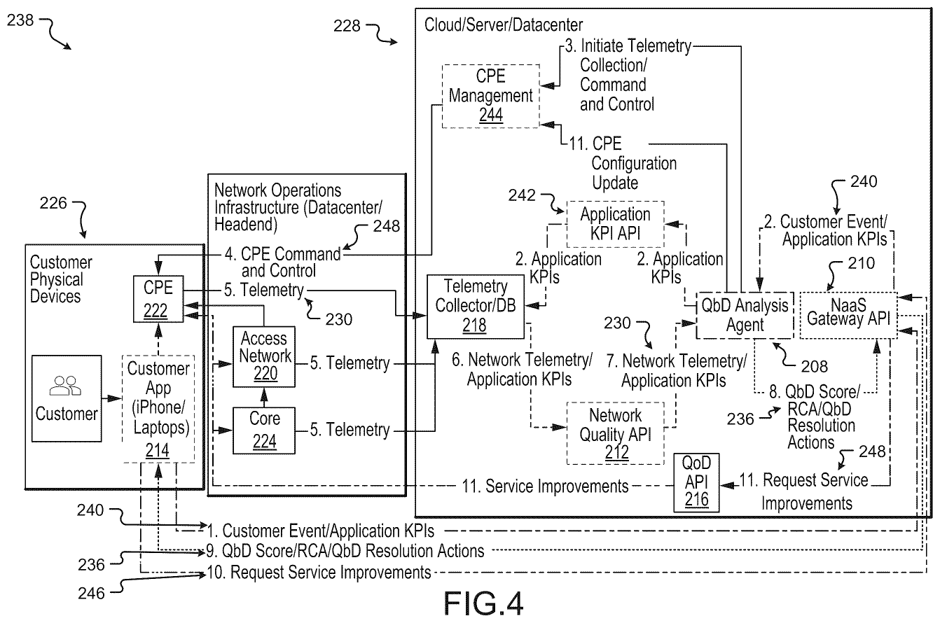

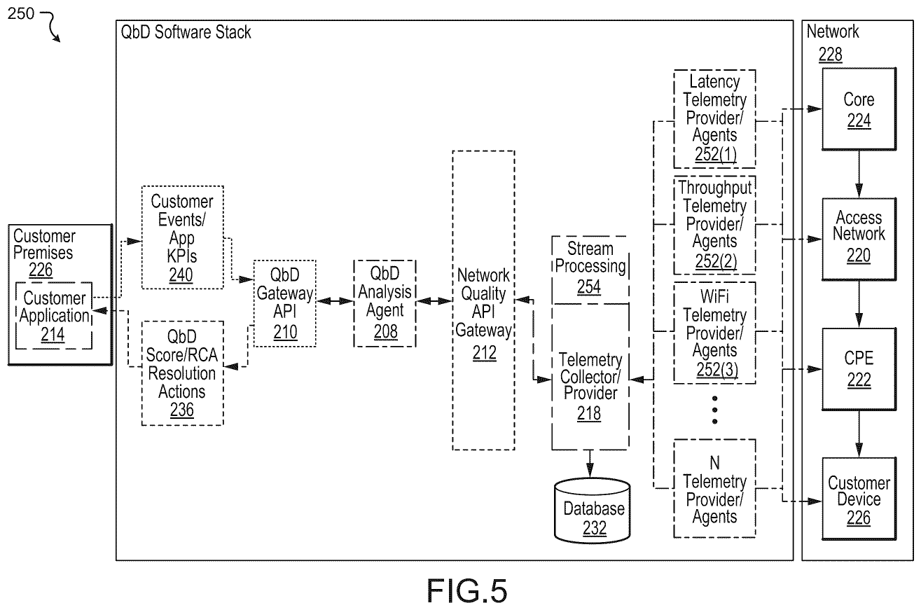

The CPE (222), the access network (220), and the core network (224) may be collectively part of the network (228). The CPE (222) may be, for example, a gateway and/or an access point and the core network (224) may be of a network operator (e.g., an MSO). Network data (230) (shown in FIG. 4) may be collected from the network (228) by the data collector (218). The data collector (218) may transmit such network data (230) to the analysis agent (208) in real-time. The data collector (218) may also store the data in a database (232) (shown in FIG. 5B).

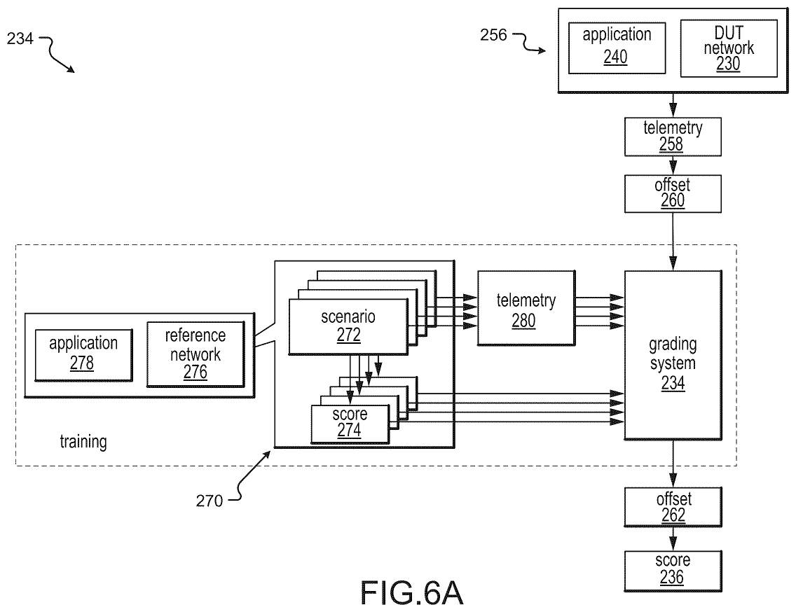

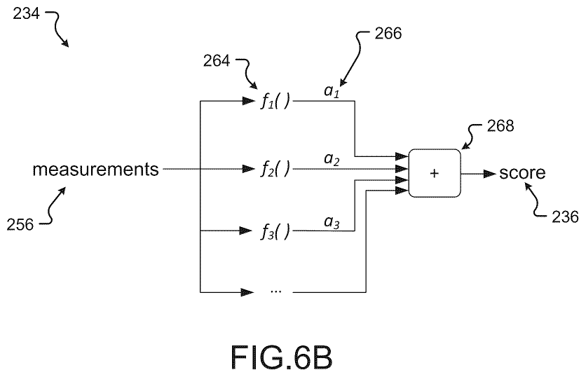

During use, the analysis agent (208) receives real-time measurements (256) (labelled in FIG. 6A) or measurements (256) from the database (232). The measurements (256) may be, for example, application KPIs (240) (labelled in FIG. 4) received from the end user application (214) via the first API (210). The network data (230) may be received from the data collector (218) (or the database (232)) via the second API (212). It will be appreciated that in some embodiments, the measurements (256) may be collected or measured in the cloud and stored in the database (232). The analysis agent (208) uses the measurements (256) as input into a scoring model (234) (shown in FIGS. 6A and 6B) to generate or output an end user score (236) that is compared to the at least one predetermined threshold (204) (shown in FIG. 3). Details of the scoring model are discussed in FIGS. 6, 7, AND 8.

As shown in FIG. 3, the at least one predetermined threshold (204) includes three ranges of predetermined thresholds displayed on an example GUI (202). In other embodiments, the at least one predetermined threshold (204) may include one predetermined threshold, two predetermined thresholds, or more than two predetermined thresholds. In the illustrated embodiment, the predetermined thresholds (204) and corresponding end user scores (236) include, for example:
Optimal=(Score) 100-80: (Threshold) latency 10 ms, packet loss <1%;
Suboptimal=(Score) 79-50: (Threshold) latency 35 ms, packet loss 1%-5%; and
Unusable=(Score)<50: (Threshold) latency >400 ms, packet loss >5%.

Turning to FIG. 4, a dataflow (238) of the system (200) is shown. The arrows in the topology and flow represent a direction of the communication, data, instructions, and/or telemetry. Additionally, the numbering may represent the order of the steps in the flow according to one embodiment. However, in other embodiments, the steps can occur in a different order. In some embodiments, some steps are in consecutive order (i.e., run in series) and other steps can occur at the same time (i.e., run in parallel). Some steps may also occur continuously while other steps may occur at a time interval or when requested. Lastly, the dataflow (238) may include more or less steps.

As shown, application KPIs (240) may be received by the first API (210) from the end user application (214). The application KPIs (240) may include one application KPI, two application KPIs, or more than two application KPIs. The application KPIs (240) may be, for example, bandwidth, framerate, packet latency, jitter, bit rate, and/or packet loss. The application KPIs (240) may be continuously received or received at a time interval (e.g., every 10 seconds, every minute, etc.) by the first API (210). It will be appreciated that the first API (210) can request, receive, and/or send the application KPIs (240), the end user scores (236), root cause analysis results, and/or resolution actions. After the first API (210) receives the application KPIs (240), the first API (210) transmits the application KPIs (240) to the analysis agent (208). The application KPIs (240) may also simultaneously or sequentially be sent to an application KPI API (242), which communicates with the database (232) to store the application KPIs (240) in the database (232).

The analysis agent (208) then requests or receives network data (230). The network data (230) may be data from the CPE (222), the access network (220), and/or the core network (224). More specifically, the network data (230) may be received from the CPE (222) via a CPE management (244), which is in communication with the CPE (222) and the analysis agent (208). In such instances, the analysis agent (208) may send a command (248) to the CPE (222) to receive network data. The CPE management (244) is also a control interface that can also increase the sending/receiving of the network data (230).

The CPE (222) is in communication with the database (232) and/or data collector (218) and may transmit network data (230) to the database (232) and/or the data collector (218). The network data (230) may also be received from the access network (220) and/or the core network (224) by the database (232) and/or the data collector (218). It will be appreciated that the network data (230) may be received and/or stored continuously, at a time interval, or by request. The third API (216) can also instruct the core network (224) and access network (220) to increase a speed of the network data (230) sent and/or increase the frequency and amount of network data (230) sent. The network data (230) may include, for example, KPIs such as packet latency, jitter, bit rate, packet loss, and/or other data.

The network data (230) is received by the analysis agent (208) from the database (232) and/or the data collector (218) via the second API (212). It will be appreciated that the second API (212) can request, receive, and/or send real-time network conditions, telemetry, and historical device measurements. As previously described, the analysis agent (208) uses the application KPIs (240) and the network data (230) (also referred to collectively as “measurements (256)”) to generate the end user score (236). The analysis agent (208) then compares the end user score (236) to the predetermined threshold (204) to determine whether the end user application (214) is experiencing an impairment.

If the end user application (214) is determined to be experiencing an impairment (e.g., the end user score is less than the predetermined threshold), then the analysis agent (208) can identify a type of impairment and/or a location of the impairment by conducting a root cause analysis. The root cause analysis may be conducted by, for example, process of elimination. In one example, the end user device's Wi-Fi connection may be checked by requesting network data and KPIs from the CPE (222), the access network (220) may be checked by requesting access network telemetry and KPIs, and the core network (224) may be checked by requesting core telemetry and KPIs. If the telemetry and KPIs for the Wi-Fi, CPE, access network, and core network are satisfactory, then the analysis agent (208) looks at the end user application (214) for the impairment. For example, is there Wi-Fi congestion on the end user's private network or is there upstream noise? If there is Wi-Fi congestion, then a resolution action to repair or improve the impairment can be identified such as prioritizing some applications and/or devices over other applications and/or devices. It will be appreciated that the root cause analysis can run through any number of scenarios to determine the impairment.

The analysis agent (208) can transmit the end user score (236), the root cause analysis, and/or the resolution action(s) to the end user application (214). In response, the end user application (214) can transmit a service improvement request (246) to the first API (210), which communications with the third API (216). The third API (216) can request, receive, and/or send actionable network optimizations, which may be automated or initiated by a user such as the end user, a developer, or a network operator. Further, the third API (216) can perform, for example, a speed boost, Wi-Fi MulitMedia packet marking, low latency DOCSIS, and low latency and low loss (LAS), among other actions in response to the service improvement request (246).

The third API (216) executes service improvements (248) based on the type and location of resolution or repair needed. For example, if the impairment is on the end user's Wi-Fi, then the first API (210) sends instructions to the third API (216), which then requests service improvements on the CPE (222). If the impairments are on the core network (224) or the access network (220), then the third API (216) requests service improvements on the access network (220) or the core network (224), which may include notifying the network operator of the impairment and resolution action.

Turning to FIG. 5, a logical topology (250) of the system (200) is shown. The logical topology (250) illustrates an example flow of data from the end user device (226) to the analysis agent (208) and from the network (228) to the analysis agent (208).

As previously described, application KPIs (240) are received by the analysis agent (208) via the first API (210) and network data (230) is received by the analysis agent (208) via the second API (212). The network data (230) may be received from the data collector (218), which collects the network data (230) from the network (228) components such as, for example, the core network (224), the access network (220), the CPE (222), and/or the end user device (226). The network data (230) may be provided by one or more telemetry data agents (252) for each type of data collected. For example, latency data may be measured by a latency agent (252(1)), throughput data may be measured by a throughput agent (252(2)), Wi-Fi data may be measured by a Wi-Fi agent (252(3)), etc. The network data (230) may also be stored in the database (232). In embodiments where the network data (230) is collected in real-time, the network data (230) can be collected and processed by a stream processor (254) rather than stored in the database (232).

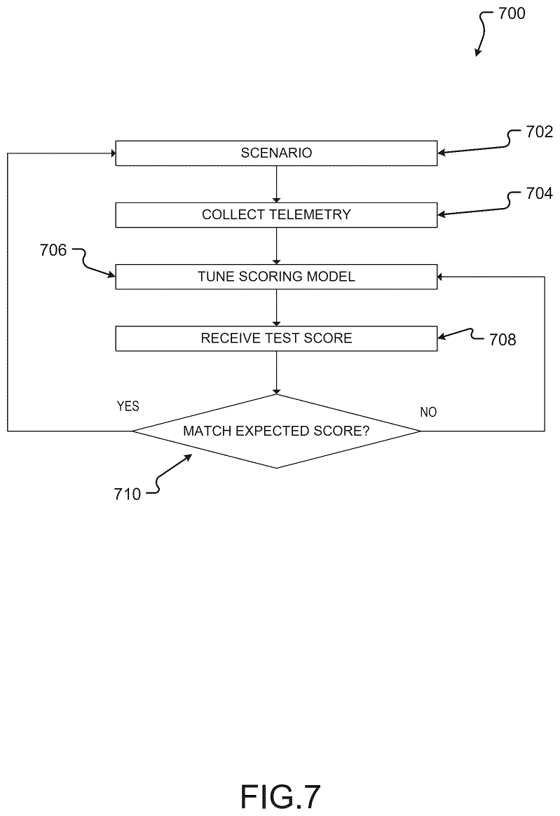

Turning to FIGS. 6A, 6B, and 7, a schematic diagram of training the scoring model (234), the scoring model (234), and a flow chart are respectively shown. As previously described, the scoring model (234) receives the measurements (256), which may be application KPIs (240) and network data (230), and outputs the end user score (236). The end user score (236) correlates to whether the end user application (214) is experiencing an impairment (e.g., the internet connection is unstable, low quality, and/or not functioning). The end user score (236) may be, for example, a scalar value that correlates to a grade that presents the health of current network operation. It will be appreciated that the scoring model (234) can be used in any application or use.

As shown in FIG. 6, measurements (256) such as application KPIs (240) and network data (230) from a network under testing may be transmitted via telemetry (258) to the scoring model (234). One or more offsets (260) may be applied to one or more measurements of the measurements (256) to, for example, match an effective region of the scoring model (234). In other words, the measurements (256) may be normalized before being inputted into the scoring model (234). The scoring model (234) then outputs the end user score (236) and an offset or adjustment (262) can be applied to the end user score (236) to match a scale (e.g., 1 to 100) and/or more accurately reflect a health of the network (228).

As shown in FIG. 7, the scoring model (234) specifically receives the measurements (256) and inputs the measurements (256) into one or more functions (264). Each function (264) outputs a value and the values from each function (264) are combined or summed at a summing function (268) to output the end user score (236). Each function (264) is also weighted by a weight (266), which can be set automatically or manually by a user such as, for example, a developer. The functions (264) may be, for example, mapping algorithms that are linear mapping, non-linear mapping (for example, polynomial mapping), machine learning, or kernal regression mapping. It will be appreciated that the functions (264) can be any type of function (264) and may include any number of functions (264) such as one function, two functions, or more than two functions. The weights (266) can be used to balance or weight the scoring model (234) between the different functions (264). For example, the weights (266) can be used to bias the scoring model (234) to be more linear, as will be illustrated in the example below.

In one specific example, each group of measurements (256) containing M-number of measurement values can be denoted as a vector x∈ [symbol] and the output end user score y can be expressed as:

$$y = {\sum }_{i} {a}_{i} {f}_{i} ( x ) {\sum }_{i} {a}_{i} = 1$$

Where aᵢ are the weights (266) and ƒᵢ are the functions (264). It will be appreciated that ƒᵢ may include any number of functions such as one function, two functions, or more than three functions. In the illustrated example, ƒᵢ may have three functions where ƒ₁ is a linear mapping, ƒ₂ is a polynomial mapping, and ƒ₃ is a kernel regression mapping. In some instances, ƒᵢ may be a machine learning model. Thus, to weight the scoring model (234) as a linear model, aᵢ can be set as a₁=1 and a₂ and a₃=0. The weights (266) can also be used to balance or adjust the functions with respect to telemetry features and telemetry samples.

Returning to FIG. 6, the scoring model (234) is derived through training using training data (270). Such training data (270) may be labelled training data and can be used to train each function of the one or more functions (264). More specifically, the training data (270) can include scenarios (272) that are created from a physical reference network (276) and/or a simulation (278). The scenarios (272) can be used to produce test measurements (256) and resulting test end user scores (274) that are transmitted to the scoring model (234) via telemetry (280). For example, noise may be applied to a reference network to create a scenario (e.g., an impaired network connection) and an end user score may be given to the performance of the reference network under such scenario. Such measurements obtained from the scenario and the end user score given may then be used as training data.

The scoring model (234) can also alternatively be trained in an iterative process as shown in a method (700) of FIG. 7. As shown, the method (700) begins with a step (702) of executing a scenario, which produces measurements. The measurements are collected at a step (704) and inputted into the scoring model at a step (706). A test score is received at a step (708). The test score is compared to an expected score at a step (710). If the test score matches or matches the expected score within a predetermined range, then the method (700) repeats with a new scenario. If the test score does not match or does not match within a range with the expected score, then the scoring model and/or the measurements that are inputted into the scoring model are adjusted and a new test score is received. Such loop (e.g., adjusting the scoring model and/or the inputs) may be repeated until the test score matches the expected score or matches the expected score within a range.

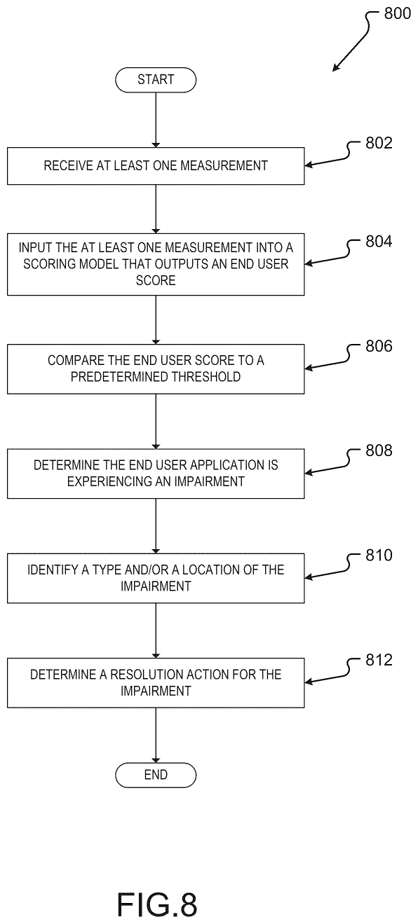

Turning to FIG. 8, a flowchart for a method 800 is provided. The method 800 may be used to determine whether an impairment is present in a network connection and to provide a resolution action for the impairment.

The method 800 includes receiving at least one measurement at step 802. The at least one measurement may be the same as or similar the measurements (256) and may be received by an analysis agent such as the analysis agent (208). As previously described, the measurements may include application KPIs such as the application KPIs (240) and network data such as the network data (230) obtained via telemetry. The application KPIs may be received from an end user application such as the end user application (214) via a first API such as the first API (210) and the network data may be received from a network such as the network (228) via a second API such as the second API (212).

The method 800 also includes inputting the at least one measurement into a scoring model that outputs an end user score at step 804. The analysis agent may input the measurement into the scoring model, which may be the same as or similar to the scoring model (234) and the end user score may be the same as or similar to the end user score (236). As previously described, the scoring model may receive the measurements and input each set of measurements into one or more functions. Each function outputs a value and the values are summed to generate the end user score. Each function is also weighted by a corresponding weight.

The method 800 also includes comparing the end user score to a predetermined threshold at step 806. The analysis agent may compare the end user score to the predetermined threshold, which may be the same as or similar to the predetermined threshold (204). The predetermined threshold may correlate to whether the end user application is experiencing an impairment such as, for example, an impairment to the end user's Wi-Fi connection.

The method (800) also includes determining that the end user application is experiencing an impairment at step (808). The end user application may be determined to be experiencing an impairment by the analysis agent when, for example, the end user score meets or is below the predetermined threshold. In other embodiments, the end user application may be determined to be experiencing an impairment when, for example, the end user score meets or is above the predetermined threshold.

The method (800) also includes identifying a type and/or a location of the impairment in step (810). Identifying the type and/or the location of the impairment may include conducting a root cause analysis by the analysis agent, as described in FIG. 4.

The method (800) also includes determining a resolution action for the impairment in step (812). The analysis agent may also determine the resolution action for the impairment based on the identified type and/or location of the impairment, as described in FIG. 4. The resolution action may also be transmitted to the end user application by the analysis agent, which may result in execution of the resolution action.

The method (800) may include more or less steps than described above. Further, any of the steps or any combination of steps may be repeated or continuously executed.

Exemplary embodiments of systems and methods for quantifying a network quality using a scoring model are described above in detail. The systems and methods of this disclosure though, are not limited to only the specific embodiments described herein, but rather, the components and/or steps of their implementation may be utilized independently and separately from other components and/or steps described herein.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, i.e., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method comprising:
receiving, by an analysis agent, at least one measurement;
inputting, by the analysis agent, the at least one measurement into a scoring model comprising a machine learning model configured to:
receive the at least one measurement;
input the at least one measurement into a plurality of functions;
weight the output of each function by a corresponding weight of a plurality of weights; and
combine the weighted output to generate the end user score; and
comparing, by the analysis agent, the end user score to a predetermined threshold.

2. The method of claim 1, further comprising:
determining that the end user application is experiencing an impairment in response to the end user score being less than the predetermined threshold;
identifying a type and a location of the impairment; and
determining a resolution action for the impairment based on type and the location of the impairment.

3. The method of claim 2, wherein the predetermined threshold comprises at least three ranges of values, and wherein the impairment is determined when the end user score is within two of the three ranges of values.

4. The method of claim 1, wherein the plurality of weights are manually defined by a developer.

5. The method of claim 1, wherein the plurality of functions are trained using labeled training data having a plurality of training data, each training data having at least one measurement and a corresponding training score.

6. The method of claim 1, wherein the at least one measurement comprises at least one application KPI received from a first (API) in communication with the end user application and network data received from a second API in communication with a network.

7. The method of claim 6, wherein the at least one application KPI comprises bandwidth, framerate, packet latency, jitter, bit rate, and packet loss and the network data comprises packet latency, jitter, bit rate, and packet loss.

8. The method of claim 1, wherein the at least one measurement is collected in the cloud and stored in at least one of a remote server or a remote database.

9. The method of claim 1, wherein the end user score is a scalar number.

10. A system comprising:
a first API in communication with an end user application and configured to receive at least one application KPI from the end user application;
a second API in communication with a network and configured to receive network data; and
an analysis agent in communication with the first API and the second API, the analysis agent configured to:
receive, in real-time, the at least one application KPI from the first API and the network data from the second API;
input the at least one application KPI and the network data into a scoring model that outputs an end user score, the end user score correlating to whether the end user application's internet connection is impaired;
compare the end user score to a predetermined threshold;
determine that the end user application is experiencing an impairment in response to the end user score is less than the predetermined threshold;
identify a type and a location of the impairment; and
determine a resolution action for the impairment based on type and the location of the impairment.

11. The system of claim 10, wherein the predetermined threshold comprises at least three ranges of values, and wherein the impairment is determined when the end user score is within two of the three ranges of values.

12. The system of claim 10, wherein the analysis agent is further configured to transmit instructions for the resolution action to at least one of an end user, a developer, or a network operator.

13. The system of claim 10, wherein the analysis agent operates on at least one of a cloud network, a remote server, or a remote database.

14. The system of claim 10, wherein the at least one application KPI and network data are collected in the cloud and stored in at least one of a remote server or a remote database.

15. The system of claim 10, wherein the at least one application KPI comprises bandwidth, framerate, packet latency, jitter, bit rate, and packet loss and the network data comprises packet latency, jitter, bit rate, and packet loss.

16. The system of claim 10, wherein the end user score is a scalar number.

17. The system of claim 10, wherein the scoring model is a machine learning model configured to:
receive the at least one application KPI and the network data;
input the at least one application KPI and the network data into a plurality of functions;
weight the output of each function by a corresponding weight of a plurality of weights; and
combine the weighted output to generate the end user score.

18. The system of claim 17, wherein the plurality of weights are manually defined by a developer.

19. The system of claim 17, wherein the plurality of functions of the scoring model are trained using labeled training data having a plurality of training data, each training data having at least one training KPIs, training network data, and a corresponding training score.

20. A system comprising:
a first API in communication with an end user application and configured to receive at least one application KPI from the end user application;
a second API in communication with a network and configured to receive network data; and
an analysis agent in communication with the first API and the second API, the analysis agent configured to:
receive, in real-time, the at least one application KPI from the first API and the network data from the second API;
input the at least one application KPI and the network data into a scoring model that outputs an end user score, the end user score correlating to whether the end user application's internet connection is impaired, wherein the scoring model is a machine learning model configured to:
receive the at least one application KPI and the network data;
input the at least one application KPI and the network data into a plurality of functions;
weight the output of each function by a corresponding weight of a plurality of weights; and
combine the weighted output to generate the end user score;
compare the end user score to a predetermined threshold;
determine that the end user application is experiencing an impairment in response to the end user score being less than the predetermined threshold;
identify a type and a location of the impairment; and
determine a resolution action for the impairment based on type and the location of the impairment.
